(19) United States
(12) Patent Application Publication
(10) Pub. No.: US 2025/0358854 A1
(43) Pub. Date: Nov. 20, 2025

(54) SUBBAND FULL DUPLEX RANDOM ACCESS OCCASION USE AND MAPPING SCENARIOS

(71) Applicant: QUALCOMM Incorporated, San Diego, CA (US)

(72) Inventors: Qian ZHANG, Basking Ridge, NJ (US); Junyi LI, Greentown, PA (US); Yan ZHOU, San Diego, CA (US)

(21) Appl. No.: 18/665,336

(22) Filed: May 15, 2024

(51) Int. Cl. H04W 74/0833; H04L 5/14

(52) U.S. Cl. CPC H04W 74/0833; H04L 5/14

(57) ABSTRACT

Methods, systems, and devices for wireless communications are described. A user equipment (UE) may perform a first synchronization signal block (SSB) to random access occasion (RO) mapping for ROs located in uplink symbols according to a first rule, and may perform a second SSB to RO mapping for ROs located in subband full duplex (SBFD) symbols according to a second rule. A UE that is experiencing cross-link interference (CLI) due to SBFD operations by another UE may transmit an indication of the sensed CLI due to the SBFD operations to the network entity. In such examples, the network entity may disable SBFD ROs, or may stop full duplex (FD) operations at an aggressor UE. The network entity may configure a transmit power, target receive power, or ramping step size for SBFD ROs to mitigate CLI. The network entity may configure different preamble formats for SBFD ROs than for other ROs.

### FIELD OF TECHNOLOGY

The following relates to wireless communications, including subband full duplex random access occasion use and mapping scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating a first set of random access occasions (ROs) corresponding to a set of uplink resources, flexible resources, or both, and a second set of ROs corresponding to a set of uplink subband resources associated with subband full duplex symbols, performing a first mapping of a first set of synchronization signal blocks (SSBs) of a set of multiple SSBs to the first set of ROs, receiving second control signaling indicating a second mapping of a second set of SSBs of the set of multiple SSBs to the second set of ROs, and transmitting a random access message via a first RO of the first set of ROs or the second set of ROs based on the first mapping and the second mapping.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of ROs corresponding to a set of uplink resources, flexible resources, or both, and a second set of ROs corresponding to a set of uplink subband resources associated with subband full duplex symbols, perform a first mapping of a first set of SSBs of a set of multiple SSBs to the first set of ROs, receive second control signaling indicating a second mapping of a second set of SSBs of the set of multiple SSBs to the second set of ROs, and transmit a random access message via a first RO of the first set of ROs or the second set of ROs based on the first mapping and the second mapping.

Another UE for wireless communications is described. The UE may include means for receiving first control signaling indicating a first set of ROs corresponding to a set of uplink resources, flexible resources, or both, and a second set of ROs corresponding to a set of uplink subband resources associated with subband full duplex symbols, means for performing a first mapping of a first set of SSBs of a set of multiple SSBs to the first set of ROs, means for receiving second control signaling indicating a second mapping of a second set of SSBs of the set of multiple SSBs to the second set of ROs, and means for transmitting a random access message via a first RO of the first set of ROs or the second set of ROs based on the first mapping and the second mapping.

A non-transitory computer-readable medium storing code for wireless communications is described. The code may include instructions executable by one or more processors to receive first control signaling indicating a first set of ROs corresponding to a set of uplink resources, flexible resources, or both, and a second set of ROs corresponding to a set of uplink subband resources associated with subband full duplex symbols, perform a first mapping of a first set of SSBs of a set of multiple SSBs to the first set of ROs, receive second control signaling indicating a second mapping of a second set of SSBs of the set of multiple SSBs to the second set of ROs, and transmit a random access message via a first RO of the first set of ROs or the second set of ROs based on the first mapping and the second mapping.

In some examples of the method, UEs, and non-transitory computer-readable medium described herein, the first set of SSBs associated with the first set of ROs according to the first mapping correspond to a first set of consecutive SSB indices in ascending order, and the second set of SSBs associated with the second set of ROs according to the second mapping correspond to a second set of SSB indices.

In some examples of the method, UEs, and non-transitory computer-readable medium described herein, the first set of SSBs associated with the first set of ROs according to the first mapping correspond to a first set of consecutive SSB indices in descending order, and the second set of SSBs associated with the second set of SSBs according to the second mapping correspond to a second set of SSB indices.

In some examples of the method, UEs, and non-transitory computer-readable medium described herein, the second set of SSBs correspond to a set of prioritized beams of a set of multiple candidate beams, each of the set of prioritized beams associated with a respective spatial direction based on traffic, UE location, channel quality, or any combination thereof.

In some examples of the method, UEs, and non-transitory computer-readable medium described herein, a set of beams corresponding to the second set of SSBs may be based on a predicted mobility of the UE, historic beam failure data corresponding to the UE, a direction of each beam of the set of beams, or any combination thereof.

In some examples of the method, UEs, and non-transitory computer-readable medium described herein, the first set of ROs correspond to uplink or flexible symbols, and the second set of ROs correspond to subband full duplex symbols configured on downlink symbols or flexible symbols.

In some examples of the method, UEs, and non-transitory computer-readable medium described herein, receiving the first control signaling may include operations, features, means, or instructions for receiving a first control message indicating the first set of ROs and receiving second control signaling indicating the second set of ROs.

In some examples of the method, UEs, and non-transitory computer-readable medium described herein, receiving the first control signaling may include operations, features, means, or instructions for receiving a first control message including the first set of ROs and the second set of ROs.

In some examples of the method, UEs, and non-transitory computer-readable medium described herein, the second control signaling includes a radio resource control message including a bitmap indicating the second set of SSBs mapped to the second set of ROs according to the second mapping.

In some examples of the method, UEs, and non-transitory computer-readable medium described herein, the second control signaling includes or a system information block indicating the second mapping of the second set of SSBs of the set of multiple SSBs to the second set of ROs.

A method for wireless communications by a UE is described. The method may include detecting a communication failure corresponding to a full duplex mode of operation and transmitting a first control message including an indication of the communication failure corresponding to the full duplex mode of operation.

A UE for wireless communications is described. The UE may include one or more memories storing processor executable code, and one or more processors coupled with the one or more memories. The one or more processors may individually or collectively be operable to execute the code to cause the UE to detect a communication failure corresponding to a full duplex mode of operation and transmit a first control message including an indication of the communication failure corresponding to the full duplex mode of operation.

Another UE for wireless communications is described. The UE may include means for detecting a communication failure corresponding to a full duplex mode of operation and means for transmitting a first control message including an indication of the communication failure corresponding to the full duplex mode of operation.

A non-transitory computer-readable medium storing code for wireless communications is described. The code may include instructions executable by one or more processors to detect a communication failure corresponding to a full duplex mode of operation and transmit a first control message including an indication of the communication failure corresponding to the full duplex mode of operation.

In some examples of the method, UEs, and non-transitory computer-readable medium described herein, the indication of the communication failure includes a request to disable a set of ROs associated with the full duplex mode of operation.

Some examples of the method, UEs, and non-transitory computer-readable medium described herein may further include operations, features, means, or instructions for receiving, based on transmitting the first control message, a second control message disabling the set of ROs.

In some examples of the method, UEs, and non-transitory computer-readable medium described herein, the indication of the communication failure includes a request to disable the full duplex mode of operation.

Some examples of the method, UEs, and non-transitory computer-readable medium described herein may further include operations, features, means, or instructions for receiving, based on transmitting the first control message, a second control message disabling the full duplex mode of operation.

Some examples of the method, UEs, and non-transitory computer-readable medium described herein may further include operations, features, means, or instructions for generating one or more cross-link interference measurements according to the full duplex mode of operation, where transmitting the first control message may be based on the one or more cross-link interference measurements satisfying a cross-link interference measurement threshold.

Some examples of the method, UEs, and non-transitory computer-readable medium described herein may further include operations, features, means, or instructions for determining that a quantity or duration of detected cross-link interference satisfies a threshold quantity or duration of cross-link interference, where transmitting the first control message may be based on the quantity of failed random access transmissions satisfying the threshold quantity of failed random access transmissions.

Some examples of the method, UEs, and non-transitory computer-readable medium described herein may further include operations, features, means, or instructions for transmitting capability information indicating that the UE may be capable of transmitting the first control message including the indication of the communication failure, where transmitting the first control message may be based on transmitting the capability information.

A method for wireless communications by a UE is described. The method may include receiving first control signaling indicating a first set of ROs corresponding to a set of uplink resources, flexible resources, or both, and a second set of ROs corresponding to a set of uplink subband resources associated with subband full duplex symbols, the first control signaling indicating a first set of random access transmission parameters for the first set of ROs, and a second set of random access transmission parameters for the second set of ROs and transmitting a random access message via a first RO of the second set of ROs according to the second set of random access transmission parameters.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of ROs corresponding to a set of uplink resources, flexible resources, or both, and a second set of ROs corresponding to a set of uplink subband resources associated with subband full duplex symbols, the first control signaling indicating a first set of random access transmission parameters for the first set of ROs, and a second set of random access transmission parameters for the second set of ROs and transmit a random access message via a first RO of the second set of ROs according to the second set of random access transmission parameters.

Another UE for wireless communications is described. The UE may include means for receiving first control signaling indicating a first set of ROs corresponding to a set of uplink resources, flexible resources, or both, and a second set of ROs corresponding to a set of uplink subband resources associated with subband full duplex symbols, the first control signaling indicating a first set of random access transmission parameters for the first set of ROs, and a second set of random access transmission parameters for the second set of ROs and means for transmitting a random access message via a first RO of the second set of ROs according to the second set of random access transmission parameters.

A non-transitory computer-readable medium storing code for wireless communications is described. The code may include instructions executable by one or more processors to receive first control signaling indicating a first set of ROs corresponding to a set of uplink resources, flexible resources, or both, and a second set of ROs corresponding to a set of uplink subband resources associated with subband full duplex symbols, the first control signaling indicating a first set of random access transmission parameters for the first set of ROs, and a second set of random access transmission parameters for the second set of ROs and transmit a random access message via a first RO of the second set of ROs according to the second set of random access transmission parameters.

In some examples of the method, UEs, and non-transitory computer-readable medium described herein, the first set of random access transmission parameters includes a first maximum random access transmit power, and the second set of random access transmission parameters includes a second maximum random access transmit power that may be lower than first maximum random access transmit power.

In some examples of the method, UEs, and non-transitory computer-readable medium described herein, the first set of random access transmission parameters includes a first power ramping step value, and the second set of random access transmission parameters includes a second power ramping step value that may be smaller than first power ramping step value.

In some examples of the method, UEs, and non-transitory computer-readable medium described herein, the first set of random access transmission parameters includes a first target received power value, and the second set of random access transmission parameters includes a second target received power value that may be smaller than first target received power value.

Some examples of the method, UEs, and non-transitory computer-readable medium described herein may further include operations, features, means, or instructions for selecting a preamble length for the random access message according to a link budget and the second maximum random access transmit power, the second target received power value, the second power ramping step value, or any combination thereof.

In some examples of the method, UEs, and non-transitory computer-readable medium described herein, the first set of random access transmission parameters includes a first preamble length, and the second set of random access transmission parameters includes a second preamble length that may be longer than first preamble length.

In some examples of the method, UEs, and non-transitory computer-readable medium described herein, the first set of random access transmission parameters includes a first preamble format, and the second set of random access transmission parameters includes a second preamble format.

In some examples of the method, UEs, and non-transitory computer-readable medium described herein, a first field in a first control message of the first control signaling includes an indication of the first preamble format, and a second field in a second control message of the first control signaling includes an indication of the second preamble format.

In some examples of the method, UEs, and non-transitory computer-readable medium described herein, the indication of the first preamble format includes an indication of a first quantity of symbols corresponding to the first preamble format, the indication of the second preamble format includes an indication of a second quantity of symbols corresponding to the second preamble format, and the second quantity of symbols may be greater than the first quantity of symbols.

In some examples of the method, UEs, and non-transitory computer-readable medium described herein, a first field in a single control message including the first control signaling includes an indication of a first quantity of symbols for a random access preamble.

Some examples of the method, UEs, and non-transitory computer-readable medium described herein may further include operations, features, means, or instructions for transmitting the random access message according to the second preamble format and the first quantity of symbols for the first preamble format, applying an offset value to the first quantity of symbols, and transmitting a second random access message via a first RO of the first set of ROs according to the first preamble format and via a second quantity of symbols that may be less than the first quantity of symbols according to the offset value.

In some examples of the method, UEs, and non-transitory computer-readable medium described herein, receiving the first control signaling may include operations, features, means, or instructions for receiving a first control message indicating the first set of ROs and receiving second control signaling including the second set of ROs.

In some examples of the method, UEs, and non-transitory computer-readable medium described herein, receiving the first control signaling may include operations, features, means, or instructions for receiving a first control message including the first set of ROs and the second set of ROs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports subband full duplex (SBFD) random access occasion (RO) use and mapping scenarios in accordance with one or more aspects of the present disclosure.

FIG. 2 shows an example of a wireless communications system that supports SBFD RO use and mapping scenarios in accordance with one or more aspects of the present disclosure.

FIG. 3 shows an example of a random access procedure that supports SBFD RO use and mapping scenarios in accordance with one or more aspects of the present disclosure.

FIG. 4 shows an example of a process flow that supports SBFD RO use and mapping scenarios in accordance with one or more aspects of the present disclosure.

FIG. 5 shows an example of a process flow that supports SBFD RO use and mapping scenarios in accordance with one or more aspects of the present disclosure.

FIG. 6 shows an example of a process flow that supports SBFD RO use and mapping scenarios in accordance with one or more aspects of the present disclosure.

FIGS. 7 and 8 show block diagrams of devices that support SBFD RO use and mapping scenarios in accordance with one or more aspects of the present disclosure.

FIG. 9 shows a block diagram of a communications manager that supports SBFD RO use and mapping scenarios in accordance with one or more aspects of the present disclosure.

FIG. 10 shows a diagram of a system including a device that supports SBFD RO use and mapping scenarios in accordance with one or more aspects of the present disclosure.

FIGS. 11 through 13 show flowcharts illustrating methods that support SBFD RO use and mapping scenarios in accordance with one or more aspects of the present disclosure.

### DETAILED DESCRIPTION

One or more user equipments (UEs) may support subband full duplex (SBFD) operations in which the UE simultaneously transmits uplink signaling and receives downlink signaling. A network entity may configure a UE with one or more random access occasions (ROs). The network may configure a first set of ROs (e.g., for half duplex random access procedures) and a second set of ROs (e.g., for SBFD random access procedures). The first and second ROs may be configured via first and second configurations, or via a single confirmation from which the first and second sets of ROs can be determined based on one or more validity rules.

The UE may receive one or more SSBs, measure the SSBs, and select an RO corresponding to one of the SSBs (e.g., based on a mapping of the SSBs to the ROs) via which to transmit a random-access message (e.g., such as a random access preamble). However, SBFD-aware UEs may be capable of SBFD random access procedures (e.g., via a different quantity of ROs than non-SBFD-aware UEs). Without a mechanism to map the SSBs to the ROs 205, the SBFD random access procedure may fail, or may be less efficient. One or more rules may be relied upon, as described herein, to determine how to map the SSBs to the ROs, to determine via which resources (e.g., ROs) the UE is to transmit a first random access message. Further, if mapping is inconsistent between an SBFD-aware UE and a UE that is not SBFD-aware, then the random access procedure may fail or be less efficient. To avoid SSB-RO mapping inconsistency for SBFD-aware UEs and other UEs in uplink resources (e.g., uplink slots or uplink symbols), the SBFD-aware UE may do SSB-RO mapping on all ROs (e.g., including ROs from the first set of ROs and ignoring ROs configured on SBFD symbols). Then, an additional SSB-RO mapping rule may be applied by SBFD-aware UEs for the additional ROs configured in SBFD symbols.

The UE may thus perform a first SSB-RO mapping for the ROs located in the uplink symbols according to a first rule or set of rules (e.g., according to an ascending or descending order of SSB indices corresponding to received SSBs), and may perform a second SSB-RO mapping for the ROs located in the SBFD symbols according to a second rule or set of rules (e.g., based on direction or beam that is most needed or prioritized, among other examples). In some examples, a UE that is experiencing cross-link interference (CLI) due to SBFD operations by another UE may transmit an indication of the sensed CLI due to the SBFD operations to the network entity. In such examples, the network entity may disable SBFD ROs, or may stop full duplex (FD) operations at the aggressor UE. In some examples, the network entity may configure a transmit power, target receive power, or ramping step size for SBFD ROs to mitigate CLI. In some examples, the network entity may configure different preamble formats for SBFD ROs than for other ROs.

Aspects of the disclosure are initially described in the context of wireless communications systems. Aspects of the disclosure are further illustrated by and described with reference to wireless communications systems, random access procedures, and process flows. Aspects of the disclosure are further illustrated by and described with reference to apparatus diagrams, system diagrams, and flowcharts that relate to SBFD RO use and mapping scenarios.

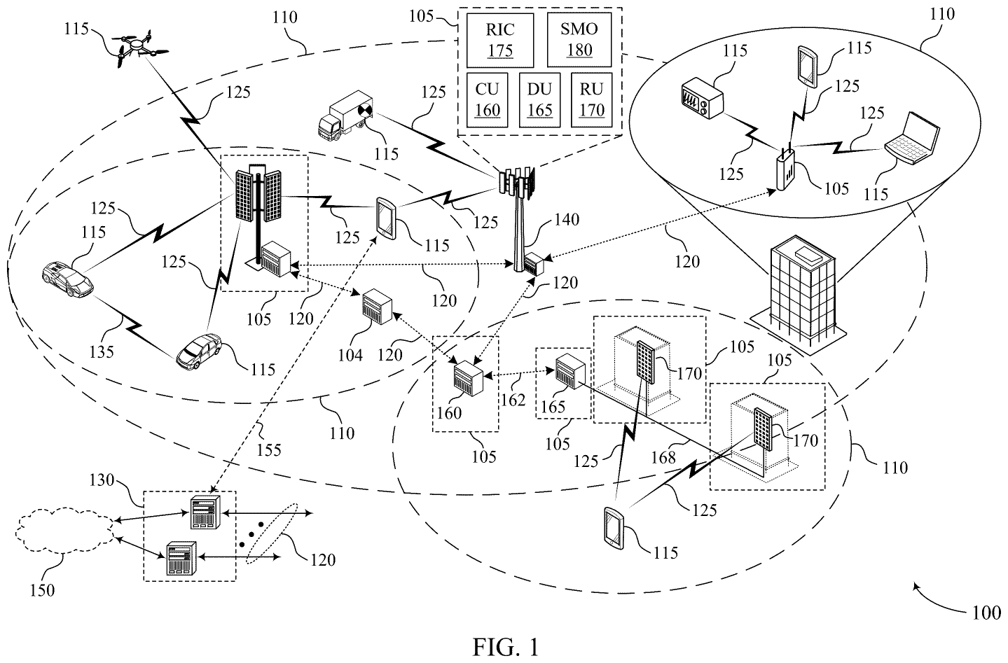

FIG. 1 shows an example of a wireless communications system 100 that supports SBFD RO use and mapping scenarios in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, UEs 115 and network entities 105 may perform SBFD operations (e.g., may support simultaneous uplink and downlink wireless communications via SBFD enabled resources). A network entity 105 may perform SBFD operations including simultaneously transmitting downlink signaling (e.g., to one UE 115) while receiving uplink signaling (e.g., from the same UE or from a different UE 115). Such SBFD downlink and uplink signaling may include MU-MIMO signaling. In some examples, the SBFD operations may be supported in a carrier (e.g., a TDD carrier) or across carriers in a CA case (e.g., intra-band CA based SBFD operations). An increased uplink duty cycle (e.g., resulting from the SBFD operations) may lead to latency reduction (e.g., it may be possible transmit uplink signaling via an uplink subband in an otherwise downlink only or flexible slot, or to receive downlink signaling in a downlink subband in an otherwise uplink only slot, which may enable latency savings), and uplink coverage improvement. SBFD operations may improve system capacity, resource utilization, and spectrum efficiency. SBFD operations may enable flexible and dynamic uplink and downlink resource adoption and use according to uplink and downlink traffic in a robust manner.

In some examples, a UEs 115 and a network entity 105 may support SBFD random access operations (e.g., a UE in RRC idle or inactive modes may perform random access in a SBFD mode). If random access is supported in SBFD symbols for SBFD-aware UEs 115, then random access latency may be reduced, physical random access channel (PRACH) collision probability may be reduced, and coverage of PRACH message 3 (e.g., in a random access procedure) may be improved. In some examples, SPFD operations may support random-access in SBFD symbols by UEs 115 in an RRC connected mode, an RRC idle mode, or an RRC inactive mode. SBFD random access procedures may improve uplink coverage (e.g., a UE 115 may utilize uplink subbands in consecutive SBFD slots or symbols to enable PRACH and message 3 repetitions). SBFD random access procedures may reduce random access channel (RACH) collision probability (e.g., may enable additional ROs within the uplink subband, which may improve RACH capacity and reduce contention-based collision probability while enabling more UEs 115 to access the network). SBFD random access procedures may reduce random access latency (e.g., may reduce the latency of random access procedures, initial access, handover procedures, etc.).

As described herein, a network entity 105 may configure ROs on SBFD symbols and non-SBFD (e.g., uplink) symbols. Such configuration may be accomplished using a single RACH configuration, where the ROs within the uplink subband in the SBFD symbols are only valid ROs for SBFD-aware UEs 115. In some examples, such configuration may be accomplished using two separate RACH configurations, including a first RACH configuration (e.g., for UEs 115 that are not SBFD-aware), and a second RACH configuration for SBFD-aware UEs. The ROs within the uplink subband in the SBFD symbols may be configured by the additional RCH configuration, and may be calid for SBFD-aware UEs 115 (e.g., but may not be considered valid ROs for UEs 115 that are not SBFD-aware).

The UE may perform a first SSB-RO mapping for the ROs located in the uplink symbols according to a first rule or set of rules (e.g., according to an ascending or descending order of SSB indices corresponding to received SSBs), and may perform a second SSB-RO mapping for the ROs located in the SBFD symbols according to a second rule or set of rules (e.g., based on direction or beam that is most needed or prioritized, among other examples). In some examples, a UE that is experiencing CLI due to SBFD operations by another UE may transmit an indication of the sensed CLI due to the SBFD operations to the network entity. In such examples, the network entity may disable SBFD ROs, or may stop FD operations at the aggressor UE. In some examples, the network entity may configure a transmit power, target receive power, or ramping step size for SBFD ROs to mitigate CLI. In some examples, the network entity may configure different preamble formats for SBFD ROs than for other ROs.

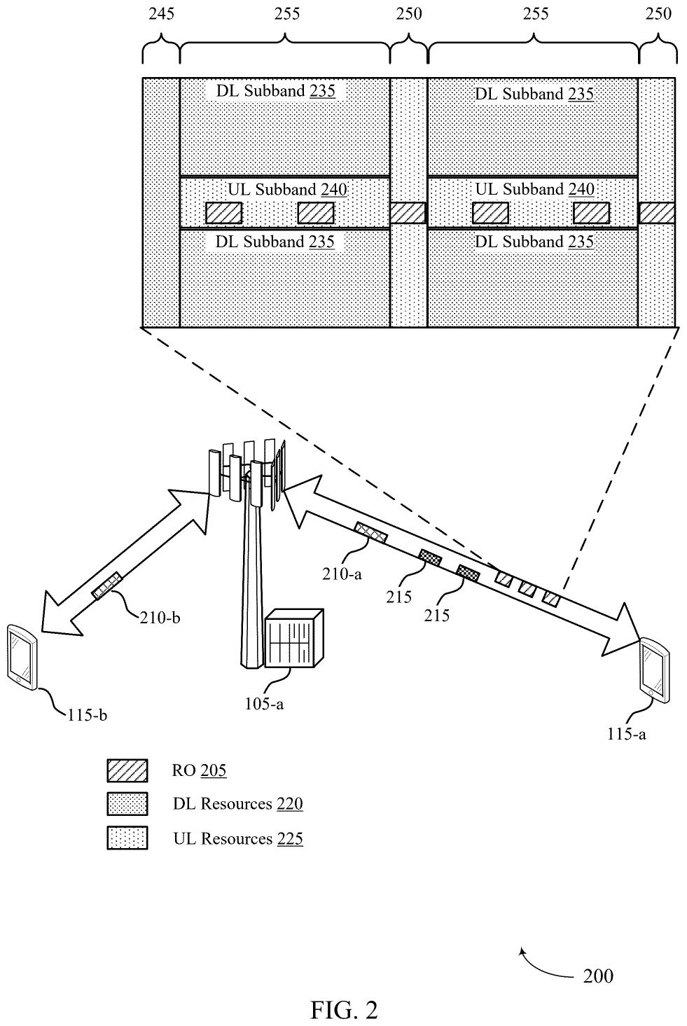

FIG. 2 shows an example of a wireless communications system 200 that supports SBFD RO use and mapping scenarios in accordance with one or more aspects of the present disclosure. The wireless communications system 200 may implement, or be implemented by, aspects of the wireless communications system 100. For example, the wireless communications system 200 may include a network entity 105-a, a UE 115-a, and a UE 115-b, which may be examples of corresponding devices described with reference to FIG. 1.

In some examples, one or more UEs 115 (e.g., the UE 115-a) may support SBFD communications, which may or may not be enabled or supported at other UEs 115 (e.g., the UE 115-b). For example, the UE 115-a may communicate uplink signaling via uplink resources 225, and may receive downlink signaling via downlink resources 220. Time resources (e.g., symbols) may be allocated (e.g., according to a pattern) as downlink resources (D symbols such as downlink symbols 245) uplink resources (U symbols such as uplink symbols 250) or flexible symbols (F or special symbols). F symbols may be utilized for uplink or downlink signaling. For an SBFD mode of operation, SBFD symbols 255 may include downlink resources 220 and uplink resources 225. SBFD symbols 255 may be scheduled on downlink or flexible resources. For example, the UE 115-a operating in an SBFD mode may simultaneously transmit uplink signaling via the uplink subband 240, and receive downlink signaling via the downlink subband 235 (e.g., during the same SBFD symbols 255). Similarly, the network entity 105-a operating in an SBFD mode may simultaneously receive uplink signaling (e.g., from the UE 115-a) via the uplink subband 240, and transmit downlink signaling (e.g., to the UE 115-a, or to the UE 115-b, or both) during the same SBFD symbol 255.

The UEs 115 may perform random access as part of one or more wireless communication procedures (e.g., a SI request, a BFR request, a connection setup, an initial access procedure, etc.). The network entity 105-a may configure the UEs 115 with one or more ROs 205 via which to transmit a random access message (e.g., random access message 1 or random access message 3 in a four-step random access procedure, or random access message A of a two-step random access procedure, message 0 or message 1 of a RACH-less procedure, etc.).

Each configuration of the ROs 205 may support random access procedures according to a separate set of parameters, which may improve performance. For example, the network entity 105-a may transmit control signaling 210 including configuration information for both a first set of ROs 205 (e.g., for SBFD symbols 255) and a second set of ROs 205 (e.g., for uplink symbols 250). The UE 115-a may identify ROs 205 in the first set of ROs and ROs 205 in the second set of ROs. As described herein, the UE 115-a may support SBFD operations, and may therefore be capable of transmitting random access messages via the ROs 205 in the SBFD symbols 255, the uplink symbols 250, or both.

The network may configure multiple sets of ROs 205 for multiple duplex types (e.g., a first configuration of a first set of ROs 205 for HD enabled UEs 115, and a second configuration of a second set of ROs 205 for SBFD enabled UEs 115). In some examples, the network entity 105-a may transmit configuration information (e.g., via the control signaling 210) indicating separate RACH configurations for each duplex type (e.g., a first configuration for SBFD and a second configuration for HD). For example, a single control message (e.g., the control signaling 210-a) may indicate a single configuration of ROs 205 that can be interpreted as two configurations (e.g., depending on whether the UE 115-a supports an SBFD mode). For example, one configuration (e.g., the SBFD configuration) may only be valid in SBFD resources (e.g., SBFD symbols 255. For example, the control signaling 210-a and the control signaling 210-b may indicate the same ROs 205. The UE 115-b (e.g., which may not support SBFD operations, or may operate in a HD mode of operation) may identify the first set of ROs 205 (e.g., located in the uplink symbols 250, because the UE 115-b does not support uplink communications via the SBFD symbols 255). The UE 115-c may identify (e.g., from the single configuration) the second configuration, and may identify the ROs 205 located in the SBFD symbols 255, or both the SBFD symbols and the uplink symbols 250).

In some examples, the network entity 105-a may transmit configuration information (e.g., via the control signaling 210) indicating a single RACH configuration for all duplex types (e.g., for SBFD and HD). A single configuration for multiple types of duplexing may result in a reduction in signaling overhead. The configuration information may define validity rules in SBFD slots. For example, the network entity 105-a may transmit control signaling 210-a to the UE 115-a. The control signaling may include a single set of parameters defining multiple ROs 205. The UE 115-a may apply the parameters to various resources (e.g., some of which may be SBFD symbols 255), and may then determine a first set of ROs 205 and a second set of ROs 205. For instance, an RO 205 may be located in an SBFD symbol 255. If SBFD communications are enabled for the SBFD slot, then the UE 115-a may support downlink communications via one or both of downlink subbands 235, and may also support uplink communications via the uplink subband 240 (e.g., where the UL resources 225 and the downlink resources 220 are located within a single carrier). In such examples, the RO 205 may be considered a valid RO, selectable by the UE 115-a for transmitting a random access message. However, if the SBFD symbol 255 is not enabled for SBFD (e.g., at the UE 115-b), then the uplink resources 225 of the uplink subband 240 may not be available for uplink signaling to the UE 115-b. Additionally, or alternatively, the first set of ROs 205 may include ROs (e.g., which are not available to a UE 115-b operating according to a HD mode because the symbols 255 will be allocated for downlink signaling in such a case), and the second set of ROs 205 may be located in downlink symbols (e.g., and not in SBFD symbols). In such examples, the UE 115-b may not be able to transmit the random access message via the RO 205 located in the SBFD symbols 255, in which case the RO 205 may not be considered a valid RO for the UE 115-b.

In some examples, a first configuration may be indicated by a first control message (e.g., the control signaling 210-b), and may indicate the first set of ROs 205 (e.g., located only in uplink symbols 250). The second configuration may be indicated by a second control message (e.g., the control signaling 210-a), and may indicate the second set of ROs 205 (e.g., located in the SBFD symbols 255, or both the uplink SBFD symbols 255 and the uplink symbols 250). The two separate RACH configurations may result in increased clarity and decreased ambiguity because there is no reason to map SSBs 215 to ROs across configurations.

Regardless of whether the ROs 205 are configured via a single configuration or via multiple configurations, the UE 115-a may map the ROs 205 to received SSBs 215. For example, the UE 115-a may receive one or more SSBs 215, and may map the received SSBs 215 to the set of ROs (e.g., the ROs 205 located in the uplink symbols 250 for the UE 115-b, and at least the ROs located in the uplink symbols 255 for the UE 115-a). Without a mechanism to map the SSBs 215 to the ROs 205, the SBFD random access procedure may fail, or may be less efficient. One or more rules may be relied upon, as described herein, to determine how to map the SSBs 215 to the ROs, to determine via which resources (e.g., ROs 205) the UE 115-a is to transmit a first random access message (e.g., msg 1 or msg A). Further, if mapping is inconsistent between the UE 115-a (e.g., an SBFD-aware UE) and the UE 115-b (e.g., a UE that is not SBFD-aware), then the random access procedure may fail or be less efficient. To avoid SSB-RO mapping inconsistency for SBFD-aware UEs 115 and other UEs 115 in uplink resources (e.g., uplink slots or uplink symbols 250), the UE 115-a may do SSB-RO mapping on all ROs 205 (e.g., including ROs 205 on uplink symbols 250) and ignoring ROs 205 configured on SBFD symbols 255 for SBFD-aware UEs 115. Then, an additional SSB-RO mapping rule may be applied to SBFD-aware UEs 115 (e.g., the UE 115-a) for the additional ROs 205 configured in SBFD symbols 255 for a single RACH configuration, or a separate SSB-RO mapping for SBFD ROs 205 with additional RACH configurations.

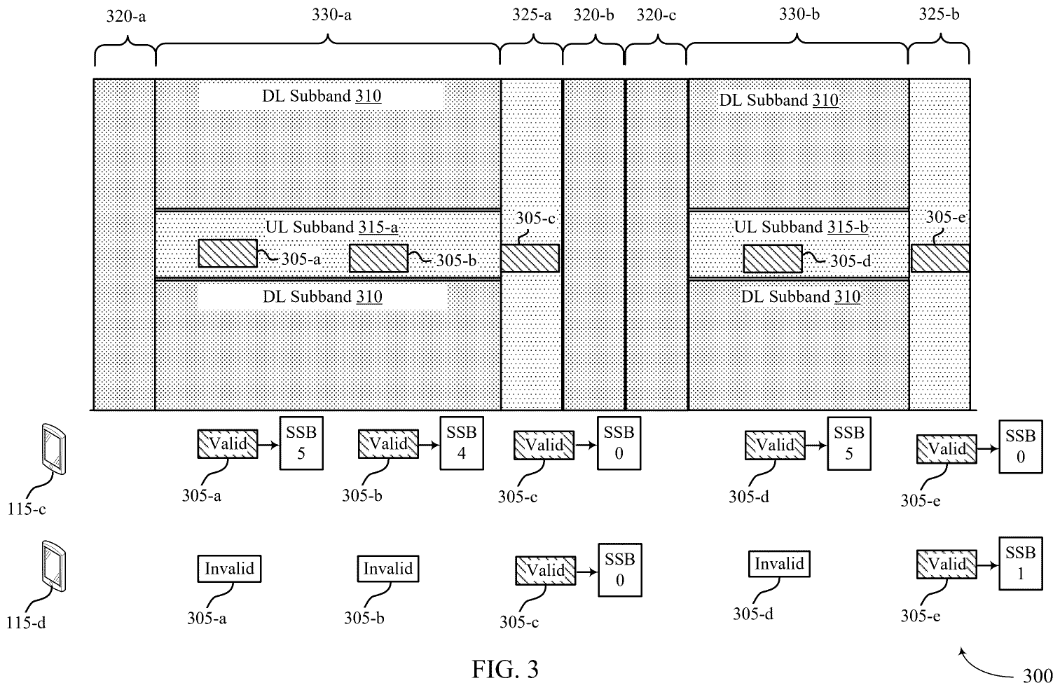

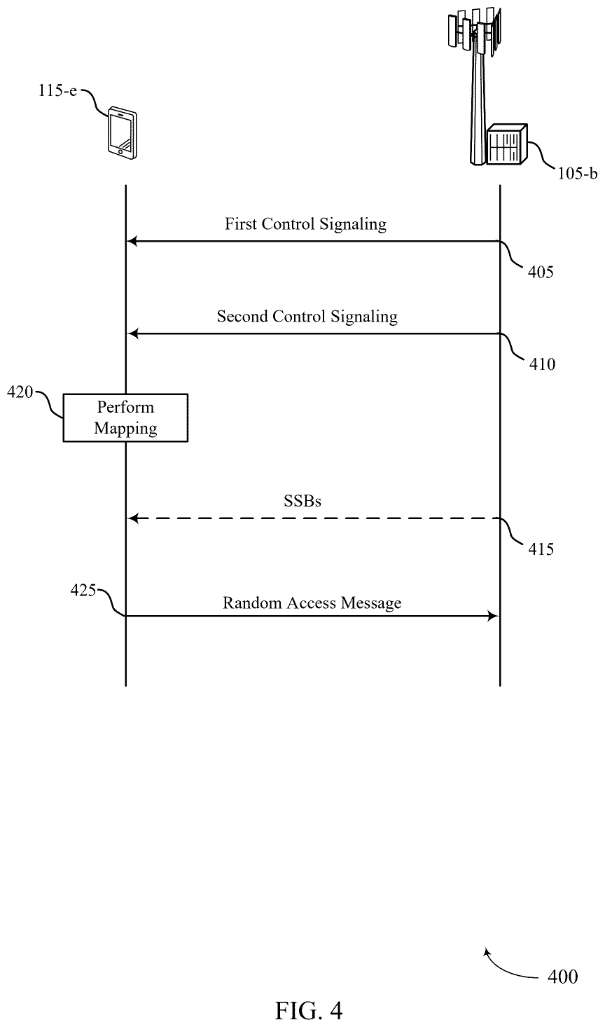

For example, as described in greater detail with reference to FIGS. 3-4, the UE 115-b may receive the control signaling 210-b. The control signaling 210-b may include a first random access configuration indicating a set of ROs 205 (e.g., in the uplink symbols 250). Or, the control signaling 210-b may include a single configuration, and the UE 115-b may determine that ROs 205 in the uplink symbols 250 are valid ROs 205, and that the ROs 205 located in downlink symbols for the UE 115-b (e.g., the SBFD symbols 255) are invalid ROs 205. The UE 115-b may perform a first SSB-RO mapping for the ROs 205 located in the uplink symbols 250 according to a first rule or set of rules (e.g., according to an ascending or descending order of SSB indices corresponding to received SSBs 215).

The UE 115-a may receive the control signaling 210-a. The control signaling 210-a may include a first random access configuration indicating a set of ROs 205 (e.g., in the uplink symbols 250), and a second random access configuration indicating a second set of ROs 205 (e.g., the SBFD ROs 205 located in the SBFD symbols 255). Or, the control signaling 210-a may include a single configuration, and the UE 115-a may determine that ROs 205 in the uplink symbols 250 are valid ROs 205, and that the ROs 205 located in the SBFD symbols 255 for the SBFD-aware UE 115-a are also valid ROs 205. In some examples, the two configurations may be defined or indicated via one or more rules as defined in one or more standards documents (e.g., with or without control signaling indicating the configurations, or preconfigured at the UE 115).

The UE 115-a may perform a first SSB-RO mapping for the ROs 205 located in the uplink symbols 250 according to a first rule or set of rules (e.g., according to an ascending or descending order of SSB indices corresponding to received SSBs 215), and may then perform a second SSB-RO mapping for the ROs 205 located in the SBFD symbols 255 according to a second rule or set of rules (e.g., based on direction or beam that is most needed or prioritized, among other examples). In some examples, a UE 115 (e.g., the UE 115-b) that is experiencing CLI due to SBFD operations by another UE 115-a may transmit an indication of the sensed CLI due to the SBFD operations. In such examples, the network entity 105-a may disable SBFD ROs, or may stop FD operations at the aggressor UE 115-a. In some examples, the network entity 105-a may configure a ramping step size for SBFD Ros to mitigate CLI. In some examples, the network entity 105-a may configure different preamble formats for SBFD ROs 205 than for other ROs 205.

FIG. 3 shows an example of a random access procedure 300 that supports SBFD RO use and mapping scenarios in accordance with one or more aspects of the present disclosure. The random access procedure may implement, or be implemented by, aspects of the wireless communications system 100 and the wireless communications system 200. For example, the random access procedure 300 may include a UE 115-c and a UE 115-d, which may be examples of corresponding devices described with reference to FIGS. 1-2. In some examples, the UE 115-c may be an SBFD aware UE 115, and the UE 115-d may be a UE 115 that is not SBFD-aware (e.g., has not enabled SBFD operations, or is not capable of SBFD operations). The UE 115-c may be capable of operation in an SBFD mode. For example, the UE 115-c may receive downlink signaling during downlink symbols 320 (e.g., the downlink symbol 320-a, the downlink symbol 320-b, and the downlink symbol 320-c), uplink signaling via the uplink symbol 325-a and the uplink symbol 325-b, and may simultaneously perform uplink signaling via the uplink subbands 315, and the downlink subbands 310, during SBFD symbols 330. For instance, during the SBFD symbols 330-a, the UE 115-c may transmit uplink signaling via uplink resources of the uplink subband 315-a and may receive downlink signaling via downlink resources of one or both of the downlink subbands 310. During the SBFD symbols 330-b, the UE 115-c may transmit uplink signaling via the uplink resources of the uplink subband 315-b, while receiving downlink signaling via the downlink resources of one or both of the downlink subbands 310.

As described in greater detail with reference to FIG. 2, the network entity 105 may configure the UE 115-c and the UE 115-d with two sets of ROs 305. For example, a single configuration of ROs 305 may be provided to the UE 115-c and to the UE 115-d. The single configuration of ROs 305 may include the RO 305-a, the RO 305-b, the RO 305-c, the RO 305-d, and the RO 305-c. The RO 305-a and the RO 305-b may be located in the uplink subband 315-a in the SBFD symbols 330-a. The RO 305-d may be located in the uplink subband 315-b of the SBFD symbols 330-b. The RO 305-c may be located in the uplink symbol 325-a, and the RO 305-e may be located in the uplink symbol 325-b. The UE 115-c, which may be an SBFD-aware UE, may determine that the RO 305-a, the RO 305-b, the RO 305-c, and the RO 305-d, and the RO 305-e are all valid ROs. However, the UE 115-d may not be an SBFD-aware UE. Thus, the UE 115-d may consider the SBFD symbols 330-a and the SBFD symbols 330-b to be downlink symbols. In such examples, the UE 115-d may determine the RO 305-a, the RO 305-b, and the RO 305-d to be invalid (e.g., and the RO 305-c and the RO 305-e to be valid). Similar techniques may be applied for two different RO configurations, in which case the network may configure the RO 305-c and the RO 305-e at the UE 115-d, and may configure all of the ROs 305 at the UE 115-c.

To avoid mapping inconsistency for SBFD-aware UEs such as the UE 115-c and non-SBFD-aware UEs such as the UE 115-d, each UE 115 may perform a first SSB-RO mapping according to the same set of rules, and SBFD-aware UEs 115 may perform an additional SSB-RO mapping. For instance, the UE 115-d may do an SB-RO mapping for the RO 305-c and the RO 305-e according to a first set of rules. The first set of rules may define an order of SSB indices (e.g., ascending or descending), a starting point for the mapping, or other mapping parameters. For instance, the UE 115-d may map (e.g., in ascending order) a first SSB 0 to the first valid RO 305-c, and may map a second SSB 1 to the second valid RO 305-c.

The UE 115-c may perform a first SSB-RO mapping on all ROs 305 configured on uplink symbols 325 (e.g., while ignoring ROs 305 configured on SBFD symbols 330 for SBFD-aware UEs 115) according to the same first set of rules. In such examples (e.g., mapping SSBs according to SSB indices in ascending order), the UE 115-c may map a first SSB 0 to the first valid RO 305-c in the first uplink symbol 325-a, and may map a second SSB 1 to the second valid RO 305-e in a second uplink symbol 325-b. The UE 115-c may also apply an additional (e.g., second) SSB-RO mapping according to an additional (e.g., second) set of rules. For example, the UE 115-c may map the valid RO 305-a, the valid RO 305-b, and the valid RO 305-d to additional SSBs according to the second set of rules. In some examples, the second set of rules may indicate that the UE 115-c is to map the valid ROs 305 in SBFD symbols 330 according to a most needed, or highest priority, SSB direction (e.g., instead of mapping in index order). Such a priority based rule may enhance RO capacity, and may improve reliability (e.g., by prioritizing the most effective, or most needed, or highest priority SSBs for random access transmissions). Such a selection of SSBs for SSB-RO mapping may apply after validity rules are applied.

In some examples, the UE 115-c may perform the SSB-RO mapping by applying SSB indices to valid ROs 305 on SBFD symbols 330 according to the priority or needed directions for the UE 115-c. For example, some UEs 115 in certain SSB directions (e.g., in certain geographic locations with reference to the network entity 105) may rely on more SBFD Ros 305. For example, the network entity 105 may predict the mobility of the UE 115-c and identify SSB directions corresponding to the direction of the UE 115-c. In some examples, the network entity 105 may determine prioritized SSB directions based on historical data or a historical model (e.g., for BFR RACH procedures in certain SSB directions performed previously by the UE 115-c or other UEs 115). For instance, some directions may correspond to poor communication (e.g., based on blockages or propagation properties, among other examples), in which case additional SSBs in that direction may be prioritized, or other less problematic SSB directions may be prioritized. In some examples, UEs 115 may be located in certain SSB directions, and those directions may be prioritized for the UE 115-c.

In some examples, the network entity 105 may configure the UE 115-c with the second set of rules for the second SSB-RO mapping (e.g., indicating the prioritized SSB directions for the additional SSB-RO mapping). For instance, the network entity 105 may transmit control signaling to the UE 115-c indicating an SSB-mapping rule for the SSB 5, the SSB 4, and the SB 7 (e.g., based on historical data, channel quality, previous transmissions, an artificial intelligence model, a historical data model, a location of the UE 115-c, among other examples). In such examples, the UE 115-c may map the SSB 0 to the RO 305-c and the SSB 1 to the RO 305-e (e.g., according to the first set of mapping rules), and may map the SSB 5 to the RO 305-a, the SSB 4 to the RO 305-b, and the SSB 5 to the RO 305-d. The UE 115-c may perform one or more measurements on the received SSBs (e.g., including the SSB 5, the SSB 4, the SSB 0, the SSB 5, and the SSB 0), and may select at least one of the ROs 305 for transmission of a random access message, or repetitions of a random access message based at least in part on the measurements and the selecting.

The network entity 105 may configure the UE 115-c with a first transmit power for SBFD ROs 305 (e.g., the SBFD RO 305-a, the SBFD RO 305-b, and the SBFD RO 305-d). In some examples, the network entity 105 may also configure the UE 115-c with a second transmit power for non-SBFD ROs 305 (e.g., the RO 305-c and the RO 305-c). The first transmit power for the SBFD ROs 305 may be less than a threshold transmit power (e.g., may be less than a maximum transmit power, which may be defined in a parameter value such as maximum_PRACH_TxPower). In some examples, the network entity 105 may set a lower target received power for SBFD ROs 305 (e.g., to mitigate UE-to-UE CLI caused by SBFD random access transmissions via SBFD ROs 305).

In some examples, the network entity 105 may configure (e.g., via control signaling) a different (e.g., lower) power ramping step for SBFD ROs 305 (e.g., to mitigate UE-to-UE CLI caused by SBFD random access transmissions via SBFD ROs 305). In such examples, if RACH transmission power is reduced (e.g., by half, such as by 3 dB), then to maintain a link budget the network entity 105 may configure (e.g., reuse) a longer preamble format. For instance, the UE 115-c may transmit a preamble via an SBFD RO 305 that is twice as long as a preamble used for a non-SBFD RO 305. The UE 115-c may transmit the longer preamble (e.g., having twice the duration of the non-SBFD preamble) at half the transmission power, resulting in the same link budget as the shorter preamble transmitted at twice the transmission power of the longer SBFD preamble. In some examples, the preamble length or format may be defined in one or more standards documents or by one or more rules, or may be indicated via control signaling.

In some examples, the network entity may configure (e.g., via control signaling) different preamble formats for SBFD ROs 305 than for non-SBFD ROs 305 (e.g., which may be referred to as ROs corresponding to a different generation, ROs corresponding to a different mode of operation, or legacy ROs). If the first set of ROs and the second set of ROs are configured in separate configurations (e.g., as opposed to a single configuration to which validity rules are applied to determine the ROs of the different sets of ROs) the network entity 105 may configure different preamble formats with two preamble fields in the two RACH configurations for SBFD ROs 305 in SBFD symbols 330 vs legacy ROs 305 in non-SBFD symbols. For example, a first configuration indicating the first set of ROs 305 (e.g., the non-SBFD ROs 305 including the RO 305-c and the RO 305-c) may include a first field indicating a second preamble format for the second set of ROs. A second configuration indicating the second set of SBFD ROs 305 (e.g., the SBFD RO 305-a, the SBFD RO 305-b, and the SBFD RO 305-d) may include a second field indicating a second preamble format for the SBFD ROs 305. The first and second field (e.g., indicating the first and second preamble formats) may include an indication of a time allocation (e.g., a duration of time or a quantity of symbols occupied for a preamble transmission for a long format, or a duration of time or a quantity of symbols occupied for a preamble transmission for a short format).

In some examples, the first set of ROs and the second set of ROs may configured via a single RACH configuration (e.g., which may indicate the first set of ROs 305 for non-SBFD-aware UEs 115-d, and the second set of ROs 305 for the SBFD-aware UEs 115-c based on application of the validity rules). In such examples, the network entity 105 may configure different preamble formats with two parameters in the preamble format field for the SBFD ROs 305. For example, the configuration may indicate a long preamble format in SBFD symbols 330, and a short preamble format for legacy ROs 305 in non-SBFD symbols. The format indication may indicate a time allocation (e.g., a duration of time or a quantity of symbols occupied for a preamble transmission for a long format, or a duration of time or a quantity of symbols occupied for a preamble transmission for a short format). In some examples, the configuration may only indicate a single time allocation for a preamble. In such examples, the UE 115-c may use a partial (e.g., a portion) of the indicated symbols occupied (e.g., as indicated by the configuration in the format field) for transmission of the short format preamble for non-SBFD symbol ROs 305, and may use the full duration of the indicated quantity of symbols for transmission via non-SBFD ROs 305.

FIG. 4 shows an example of a process flow 400 that supports SBFD RO use and mapping scenarios in accordance with one or more aspects of the present disclosure. The process flow 400 may implement, or be implemented by, aspects of the wireless communications system 100, the wireless communications system 200, the random access procedure 300, or any combination thereof. For example, the process flow 400 may include a network entity 105-b, and a UE 115-c, which may be examples of corresponding devices described with reference to FIGS. 1-3.

At 405, the UE 115-c may receive (e.g., from the network entity 105-b) first control signaling. The first control signaling may indicate a first set of ROs corresponding to a set of uplink resources, flexible resources, or both, and a second set of ROs corresponding to a set of uplink subband resources associated with SBFD symbols. The first set of ROs may be legacy ROs (e.g., configured on legacy uplink symbols or flexible symbols). The second set of ROs may be configured on SBFD symbols (e.g., which are semi-statically configured on legacy downlink symbols or flexible symbols). A first mapping (e.g., a first set of mapping rules) may indicate a first mapping of a first set of SSBs of multiple SSBs to the first set of ROs. The first control signaling may include a first control message (e.g., a first configuration) indicating the first set of ROs, and a second control message (e.g., a second configuration) indicating the second set of ROs. In some examples, the first control signaling may include a first control message (e.g., a single configuration) indicating the first set of ROs, the second set of ROs, or a combination thereof (e.g., according to one or more validity rules).

At 410, the UE 115-e may receive (e.g., from the network entity 105-b) second control signaling. The second control signaling may indicate a second mapping of a second set of SSBs of the multiple of SSBs to the second set of ROs. The second control signaling may be an RRC message including a bitmap indicating the second set of SSBs mapped to the second set of ROs according to the second mapping.

In some examples, the first set of SSBs associated with the first set of ROs according to the first mapping may correspond to a first set of consecutive SSB indices in ascending order or descending order. The second set of SSBs associated with the second set of ROs according to the second mapping may correspond to a second set of SSB indices (e.g., prioritized SSB directions). In some examples, the second set of SSBs may correspond to a set of prioritized beams of multiple candidate beams, each of the set of prioritized beams associated with a respective spatial direction based at least in part on traffic, UE location, channel quality, or any combination thereof. In some examples, the set of prioritized beams may correspond to the second set of SSBs, and may be based at least in part on a predicted mobility of the UE, historic beam failure data corresponding to the UE, a direction of each beam of the set of beams, or any combination thereof.

At 415, the UE 115-e may perform a mapping procedure (e.g., SSB-RO mapping). For example, the UE 115-e may perform a first mapping of the first set of SSBs to the first set of ROs. The UE 115-e may perform the second mapping of the second set of SSBs to the second set of ROs.

At 420, the UE 115-e may receive one or more of the multiple SSBs. The UE 115-e may perform one or more measurements on the received SSBs. The UE 115-e may select at least one of the SSBs based on the measurements. The UE 115-e may select an RO of the first set of ROs, the second set of ROs, or both, based at least in part on the selecting and the SSB-RO mapping performed at 420.

At 425, the UE 115-e may transmit a random access message via the selected first RO of the first set of ROs or the second set of ROs based at least in part on the first mapping, the second mapping, or both.

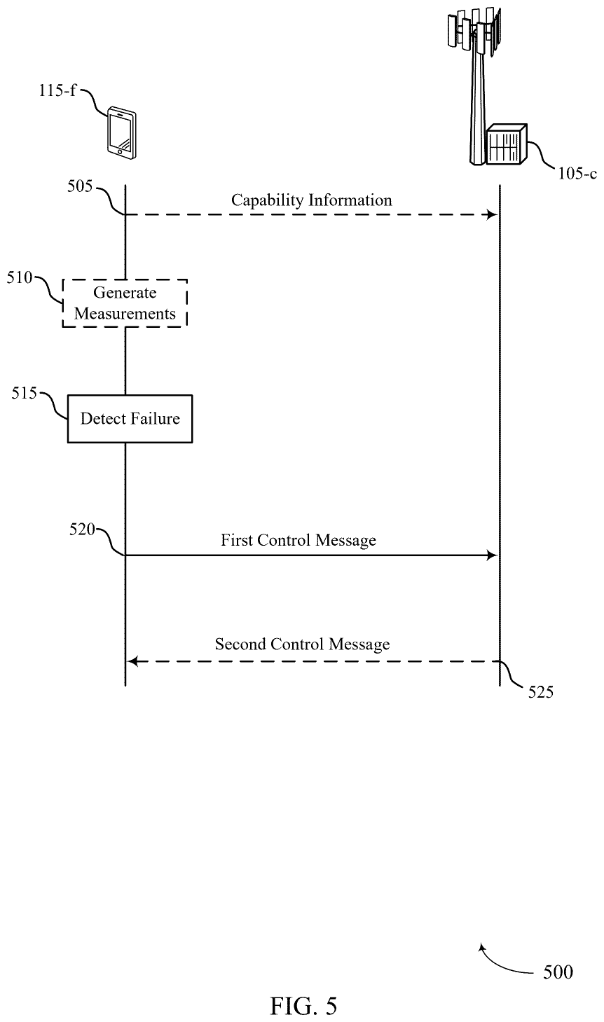

FIG. 5 shows an example of a process flow 500 that supports SBFD RO use and mapping scenarios in accordance with one or more aspects of the present disclosure. The process flow 500 may implement, or be implemented by, aspects of the wireless communications system 100, the wireless communications system 200, the random access procedure 300, the process flow 400, or any combination thereof. For example, the process flow 500 may include a network entity 105-c, and a UE 115-f, which may be examples of corresponding devices described with reference to FIGS. 1-4.

The UE 115-e may monitor for and receive downlink signaling from the network entity 105-b. The network entity 105-c may communicate with one or more additional UEs 115 (e.g., may receive random access signaling via one or more SBFD ROs from another UE 115). The UE 115-f may experience CLI (e.g., caused by the random-access signaling by the other UEs 115). For instance, in a hotspot scenario, multiple UEs 115 may attempt to transmit random access signaling via one or more ROs, in which case the UE 115-f (e.g., a victim downlink UE) may persistently experience interference caused by the RACH transmissions of the multiple other UEs 115. Techniques described herein may provide a mechanism for the victim UE 115-f to address the CLI caused by the other UEs 115.

The UE 115-f may detect a communication failure at 515. For example, the UE 115-f may generate one or more measurements (e.g., CLI measurements) at 510. If the measured CLI satisfies (e.g., exceeds) a CLI threshold, then the UE 115-f may determine that the communication failure has occurred (e.g., may determine that the RA transmissions by other UEs via SBFD ROs is causing CLI at the UE 115-f and negatively impacting downlink reception at the UE 115-f). In some examples, the UE 115-f may determine that a quantity or duration of detected CLI satisfies a threshold quantity or duration of CLI.

At 520 (e.g., based on the detected failure), the UE 115-f may transmit a first control message. The first control message may include an indication of the communication failure corresponding to the full duplex mode of operation. For example, the UE 115-f may transmit an indication (e.g., a 1-bit indication) to the serving network entity 105-c. The indication may be a 1-bit indication. The indication may be a request to either stop RACH procedures on SBFD symbols, or to disable SBFD ROs, or to terminate full duplex operations (e.g., at the other UEs). For instance, the indication of the communication failure may include a request to disable a set of ROs associated with the full duplex mode of operation (e.g., at another UE). In such examples (e.g., at 525), the UE 115-f may receive a second control message disabling the set of ROs. In some examples, the indication of the communication failure may include a request to disable the full duplex mode of operation. IN such examples (e.g., at 525), the UE 115-f may receive a second control message disabling the full duplex mode of operation.

In some examples, at 505, the UE 115-f may transmit capability information indicating that the UE 115-f is capable of transmitting the first control message at 520. The UE 115-f may transmit the first control message at 520 according to the capability information. In some examples, techniques described with reference to FIG. 5 may apply in specific use cases (e.g., if one or more conditions are satisfied, the UE 115-f may transmit the capability information, the first control message, or both).

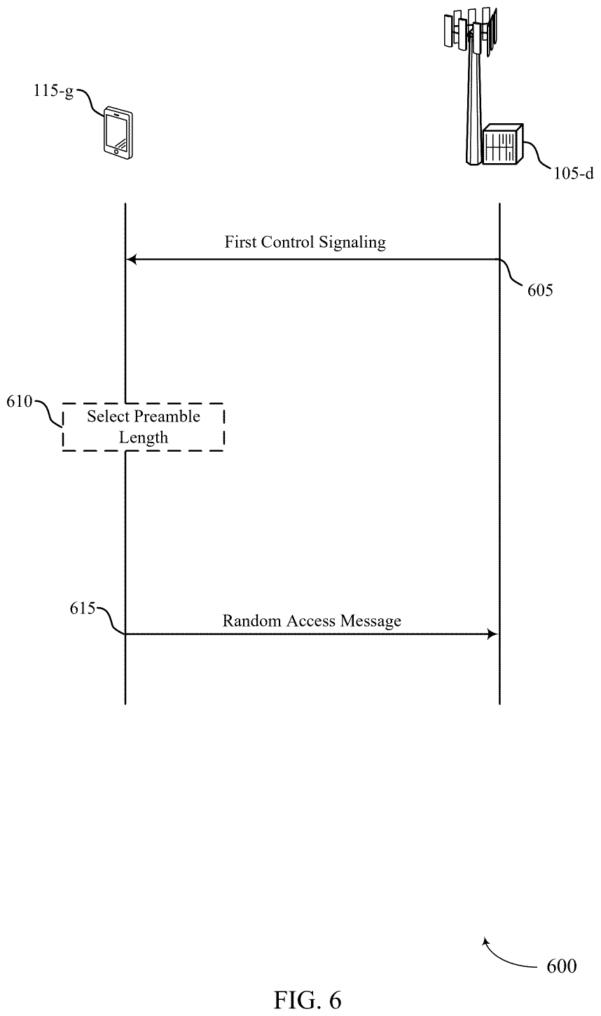

FIG. 6 shows an example of a process flow 600 that supports SBFD RO use and mapping scenarios in accordance with one or more aspects of the present disclosure. The process flow 600 may implement, or be implemented by, aspects of the wireless communications system 100, the wireless communications system 200, the random access procedure 300, the process flow 400, the process flow 500, or any combination thereof. For example, the process flow 600 may include a network entity 105-d, and a UE 115-g, which may be examples of corresponding devices described with reference to FIGS. 1-5.

At 605, the UE 115-g may receive first control signaling. The first control signaling may indicate a first set of ROs corresponding to a set of uplink resources, flexible resources, or both, and a second set of ROs corresponding to a set of uplink subband resources associated with SBFD symbols. The first control signaling may indicate a first set of random access transmission parameters for the first set of ROs, and a second set of random access transmission parameters for the second set of ROs. The first control signaling may include a first control message (e.g., a first configuration) indicating the first set of ROs, and a second control message (e.g., a second configuration) indicating the second set of ROs. In some examples, the first control message may include the first set of ROs and the second set of ROs.

In some examples, the first set of random access transmission parameters may include a first threshold (e.g., maximum) random access transmit power, and the second set of random access transmission parameters may include a second threshold (e.g., maximum) random access transmit power that is lower than first threshold random access transmit power. In some examples, the first set of random access transmission parameters may include a first power ramping step value, and the second set of random access transmission parameters may include a second power ramping step value that is smaller than first power ramping step value. In some examples, the first set of random access transmission parameters may include a first target received power value, and the second set of random access transmission parameters may include a second target received power value that is smaller than first target received power value. In some examples, the first set of random access transmission parameters may include a first preamble length, and the second set of random access transmission parameters may include a second preamble length that is longer than first preamble length. In some examples, the first set of random access transmission parameters may include a first preamble format, and the second set of random access transmission parameters may include a second preamble duration. A first field in a first control message of the first control signaling may include an indication of the first preamble format, and a second field in a second control message of the first control signaling may include an indication of the second preamble format. The indication of the first preamble format may include an indication of a first quantity of symbols corresponding to the first preamble format, the indication of the second preamble format may include an indication of a second quantity of symbols corresponding to the second preamble format, and the second quantity of symbols is greater than the first quantity of symbols.

At 610, the UE 115-g may select a preamble length for a random access message. The UE 115-g may select the preamble length for transmission of the random access message at 615 according to a link budget and the second maximum random access transmit power, the second target received power value, the second power ramping step value, or any combination thereof.

At 615, the UE 115-g may transmit a random access message via a first RO of the second set of ROs according to the second set of random access transmission parameters.

In some examples, a first field in a single control message including the first control signaling may include an indication of a first quantity of symbols for a random access preamble. In such examples, the UE 115-g may transmit the random access message according to the second preamble format and the first quantity of symbols for the first preamble format. The UE 115-g may apply an offset value to the first quantity of symbols, and may then transmit a second random access message via a first RO of the first set of ROs according to the first preamble format and via a second quantity of symbols that is less than the first quantity of symbols according to the offset value.

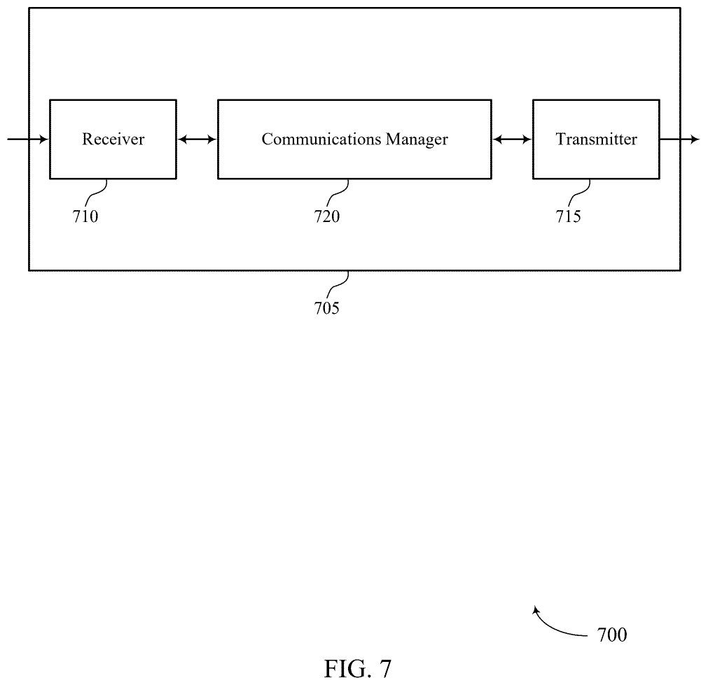

FIG. 7 shows a block diagram 700 of a device 705 that supports SBFD RO use and mapping scenarios in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SBFD RO use and mapping scenarios). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SBFD RO use and mapping scenarios). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of SBFD RO use and mapping scenarios as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols. The communications manager 720 is capable of, configured to, or operable to support a means for performing a first mapping of a first set of SSBs of a set of multiple SSBs to the first set of ROs. The communications manager 720 is capable of, configured to, or operable to support a means for receiving second control signaling indicating a second mapping of a second set of SSBs of the set of multiple SSBs to the second set of ROs. The communications manager 720 is capable of, configured to, or operable to support a means for transmitting a random access message via a first RO of the first set of ROs or the second set of ROs based on the first mapping and the second mapping.

Additionally, or alternatively, the communications manager 720 may support wireless communications in accordance with examples as disclosed herein. For example, the communications manager 720 is capable of, configured to, or operable to support a means for detecting a communication failure corresponding to a full duplex mode of operation. The communications manager 720 is capable of, configured to, or operable to support a means for transmitting a first control message including an indication of the communication failure corresponding to the full duplex mode of operation.

Additionally, or alternatively, the communications manager 720 may support wireless communications in accordance with examples as disclosed herein. For example, the communications manager 720 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols, the first control signaling indicating a first set of random access transmission parameters for the first set of ROs, and a second set of random access transmission parameters for the second set of ROs. The communications manager 720 is capable of, configured to, or operable to support a means for transmitting a random access message via a first RO of the second set of ROs according to the second set of random access transmission parameters.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for random access procedures resulting in more efficient random access procedures, improved initial access, decreased latency, more efficient use of available resources, and improved user experience.

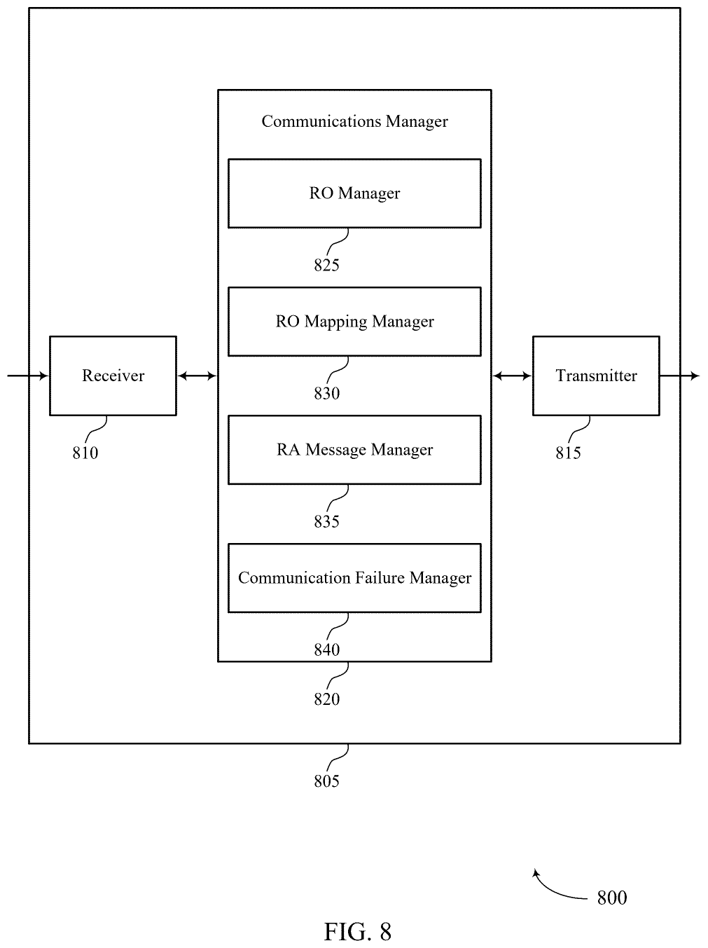

FIG. 8 shows a block diagram 800 of a device 805 that supports SBFD RO use and mapping scenarios in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SBFD RO use and mapping scenarios). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SBFD RO use and mapping scenarios). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of SBFD RO use and mapping scenarios as described herein. For example, the communications manager 820 may include a RO manager 825, a RO mapping manager 830, a RA message manager 835, a communication failure manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The RO manager 825 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols. The RO mapping manager 830 is capable of, configured to, or operable to support a means for performing a first mapping of a first set of SSBs of a set of multiple SSBs to the first set of ROs. The RO mapping manager 830 is capable of, configured to, or operable to support a means for receiving second control signaling indicating a second mapping of a second set of SSBs of the set of multiple SSBs to the second set of ROs. The RA message manager 835 is capable of, configured to, or operable to support a means for transmitting a random access message via a first RO of the first set of ROs or the second set of ROs based on the first mapping and the second mapping.

Additionally, or alternatively, the communications manager 820 may support wireless communications in accordance with examples as disclosed herein. The communication failure manager 840 is capable of, configured to, or operable to support a means for detecting a communication failure corresponding to a full duplex mode of operation. The communication failure manager 840 is capable of, configured to, or operable to support a means for transmitting a first control message including an indication of the communication failure corresponding to the full duplex mode of operation.

Additionally, or alternatively, the communications manager 820 may support wireless communications in accordance with examples as disclosed herein. The RO manager 825 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols, the first control signaling indicating a first set of random access transmission parameters for the first set of ROs, and a second set of random access transmission parameters for the second set of ROs. The RA message manager 835 is capable of, configured to, or operable to support a means for transmitting a random access message via a first RO of the second set of ROs according to the second set of random access transmission parameters.

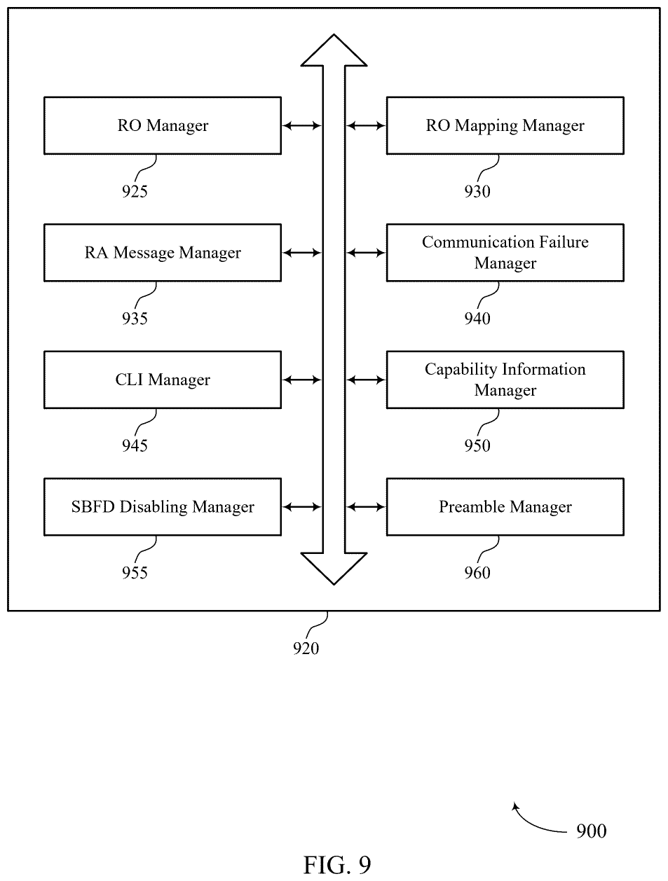

FIG. 9 shows a block diagram 900 of a communications manager 920 that supports SBFD RO use and mapping scenarios in accordance with one or more aspects of the present disclosure. The communications manager 920 may be an example of aspects of a communications manager 720, a communications manager 820, or both, as described herein. The communications manager 920, or various components thereof, may be an example of means for performing various aspects of SBFD RO use and mapping scenarios as described herein. For example, the communications manager 920 may include a RO manager 925, a RO mapping manager 930, a RA message manager 935, a communication failure manager 940, a CLI manager 945, a capability information manager 950, an SBFD disabling manager 955, a preamble manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The RO manager 925 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols. The RO mapping manager 930 is capable of, configured to, or operable to support a means for performing a first mapping of a first set of SSBs of a set of multiple SSBs to the first set of ROs. In some examples, the RO mapping manager 930 is capable of, configured to, or operable to support a means for receiving second control signaling indicating a second mapping of a second set of SSBs of the set of multiple SSBs to the second set of ROs. The RA message manager 935 is capable of, configured to, or operable to support a means for transmitting a random access message via a first RO of the first set of ROs or the second set of ROs based on the first mapping and the second mapping.

In some examples, the first set of SSBs associated with the first set of ROs according to the first mapping correspond to a first set of consecutive SSB indices in ascending order, and the second set of SSBs associated with the second set of ROs according to the second mapping correspond to a second set of SSB indices.

In some examples, the first set of SSBs associated with the first set of ROs according to the first mapping correspond to a first set of consecutive SSB indices in descending order, and the second set of SSBs associated with the second set of SSBs according to the second mapping correspond to a second set of SSB indices.

In some examples, the second set of SSBs correspond to a set of prioritized beams of a set of multiple candidate beams, each of the set of prioritized beams associated with a respective spatial direction based on traffic, UE location, channel quality, or any combination thereof.

In some examples, a set of beams corresponding to the second set of SSBs are based on a predicted mobility of the UE, historic beam failure data corresponding to the UE, a direction of each beam of the set of beams, or any combination thereof.

In some examples, the first set of ROs correspond to uplink or flexible symbols, and the second set of ROs correspond to SBFD symbols configured on downlink symbols or flexible symbols.

In some examples, to support receiving the first control signaling, the RO manager 925 is capable of, configured to, or operable to support a means for receiving a first control message indicating the first set of ROs. In some examples, to support receiving the first control signaling, the RO manager 925 is capable of, configured to, or operable to support a means for receiving second control signaling indicating the second set of ROs.

In some examples, to support receiving the first control signaling, the RO manager 925 is capable of, configured to, or operable to support a means for receiving a first control message including the first set of ROs and the second set of ROs.

In some examples, the second control signaling includes a radio resource control message including a bitmap indicating the second set of SSBs mapped to the second set of ROs according to the second mapping.

In some examples, the second control signaling includes or a system information block indicating the second mapping of the second set of SSBs of the set of multiple SSBs to the second set of ROs.

Additionally, or alternatively, the communications manager 920 may support wireless communications in accordance with examples as disclosed herein. The communication failure manager 940 is capable of, configured to, or operable to support a means for detecting a communication failure corresponding to a full duplex mode of operation. In some examples, the communication failure manager 940 is capable of, configured to, or operable to support a means for transmitting a first control message including an indication of the communication failure corresponding to the full duplex mode of operation.

In some examples, the indication of the communication failure includes a request to disable a set of ROs associated with the full duplex mode of operation.

In some examples, the RO manager 925 is capable of, configured to, or operable to support a means for receiving, based on transmitting the first control message, a second control message disabling the set of ROs.

In some examples, the indication of the communication failure includes a request to disable the full duplex mode of operation.

In some examples, the SBFD disabling manager 955 is capable of, configured to, or operable to support a means for receiving, based on transmitting the first control message, a second control message disabling the full duplex mode of operation.

In some examples, the CLI manager 945 is capable of, configured to, or operable to support a means for generating one or more cross-link interference measurements according to the full duplex mode of operation, where transmitting the first control message is based on the one or more cross-link interference measurements satisfying a cross-link interference measurement threshold.

In some examples, the CLI manager 945 is capable of, configured to, or operable to support a means for determining that a quantity or duration of detected cross-link interference satisfies a threshold quantity or duration of cross-link interference, where transmitting the first control message is based on the quantity of failed random access transmissions satisfying the threshold quantity of failed random access transmissions.

In some examples, the capability information manager 950 is capable of, configured to, or operable to support a means for transmitting capability information indicating that the UE is capable of transmitting the first control message including the indication of the communication failure, where transmitting the first control message is based on transmitting the capability information.

Additionally, or alternatively, the communications manager 920 may support wireless communications in accordance with examples as disclosed herein. In some examples, the RO manager 925 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols, the first control signaling indicating a first set of random access transmission parameters for the first set of ROs, and a second set of random access transmission parameters for the second set of ROs. In some examples, the RA message manager 935 is capable of, configured to, or operable to support a means for transmitting a random access message via a first RO of the second set of ROs according to the second set of random access transmission parameters.

In some examples, the first set of random access transmission parameters includes a first maximum random access transmit power, and the second set of random access transmission parameters includes a second maximum random access transmit power that is lower than first maximum random access transmit power.

In some examples, the first set of random access transmission parameters includes a first power ramping step value, and the second set of random access transmission parameters includes a second power ramping step value that is smaller than first power ramping step value.

In some examples, the first set of random access transmission parameters includes a first target received power value, and the second set of random access transmission parameters includes a second target received power value that is smaller than first target received power value.

In some examples, the preamble manager 960 is capable of, configured to, or operable to support a means for selecting a preamble length for the random access message according to a link budget and the second maximum random access transmit power, the second target received power value, the second power ramping step value, or any combination thereof.

In some examples, the first set of random access transmission parameters includes a first preamble length, and the second set of random access transmission parameters includes a second preamble length that is longer than first preamble length.

In some examples, the first set of random access transmission parameters includes a first preamble format, and the second set of random access transmission parameters includes a second preamble format.

In some examples, a first field in a first control message of the first control signaling includes an indication of the first preamble format, and a second field in a second control message of the first control signaling includes an indication of the second preamble format.

In some examples, the indication of the first preamble format includes an indication of a first quantity of symbols corresponding to the first preamble format, the indication of the second preamble format includes an indication of a second quantity of symbols corresponding to the second preamble format, and the second quantity of symbols is greater than the first quantity of symbols.

In some examples, a first field in a single control message including the first control signaling includes an indication of a first quantity of symbols for a random access preamble.

In some examples, the RA message manager 935 is capable of, configured to, or operable to support a means for transmitting the random access message according to the second preamble format and the first quantity of symbols for the first preamble format. In some examples, the RA message manager 935 is capable of, configured to, or operable to support a means for applying an offset value to the first quantity of symbols. In some examples, the RA message manager 935 is capable of, configured to, or operable to support a means for transmitting a second random access message via a first RO of the first set of ROs according to the first preamble format and via a second quantity of symbols that is less than the first quantity of symbols according to the offset value.

In some examples, to support receiving the first control signaling, the RO manager 925 is capable of, configured to, or operable to support a means for receiving a first control message indicating the first set of ROs. In some examples, to support receiving the first control signaling, the RO manager 925 is capable of, configured to, or operable to support a means for receiving second control signaling including the second set of ROs.

In some examples, to support receiving the first control signaling, the RO manager 925 is capable of, configured to, or operable to support a means for receiving a first control message including the first set of ROs and the second set of ROs.

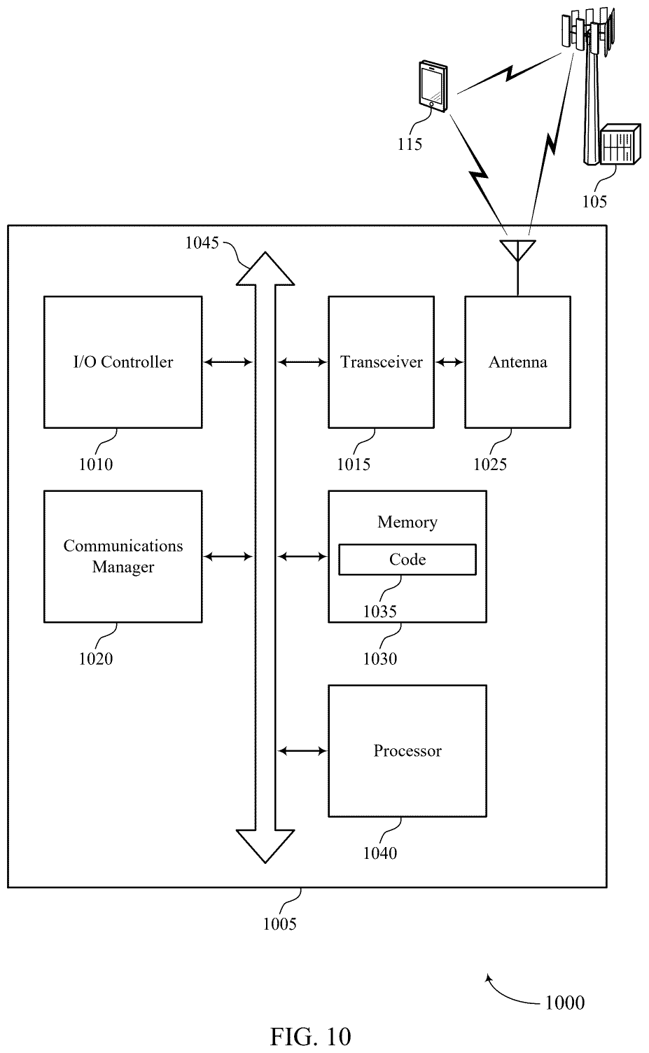

FIG. 10 shows a diagram of a system 1000 including a device 1005 that supports SBFD RO use and mapping scenarios in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting SBFD RO use and mapping scenarios). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols. The communications manager 1020 is capable of, configured to, or operable to support a means for performing a first mapping of a first set of SSBs of a set of multiple SSBs to the first set of ROs. The communications manager 1020 is capable of, configured to, or operable to support a means for receiving second control signaling indicating a second mapping of a second set of SSBs of the set of multiple SSBs to the second set of ROs. The communications manager 1020 is capable of, configured to, or operable to support a means for transmitting a random access message via a first RO of the first set of ROs or the second set of ROs based on the first mapping and the second mapping.

Additionally, or alternatively, the communications manager 1020 may support wireless communications in accordance with examples as disclosed herein. For example, the communications manager 1020 is capable of, configured to, or operable to support a means for detecting a communication failure corresponding to a full duplex mode of operation. The communications manager 1020 is capable of, configured to, or operable to support a means for transmitting a first control message including an indication of the communication failure corresponding to the full duplex mode of operation.

Additionally, or alternatively, the communications manager 1020 may support wireless communications in accordance with examples as disclosed herein. For example, the communications manager 1020 is capable of, configured to, or operable to support a means for receiving first control signaling indicating a first set of ROs corresponding to a set of uplink resources, flexible resources, or both, and a second set of ROs corresponding to a set of uplink subband resources associated with SBFD symbols, the first control signaling indicating a first set of random access transmission parameters for the first set of ROs, and a second set of random access transmission parameters for the second set of ROs. The communications manager 1020 is capable of, configured to, or operable to support a means for transmitting a random access message via a first RO of the second set of ROs according to the second set of random access transmission parameters.

By including or configuring the communications manager 1020 in accordance with examples as described herein, the device 1005 may support techniques for random access procedures resulting in more efficient random access procedures, improved initial access, decreased latency, more efficient use of available resources, increased throughput, and improved user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of SBFD RO use and mapping scenarios as described herein, or the at least one processor 1040 and the at least one memory 1030 may be otherwise configured to, individually or collectively, perform or support such operations.

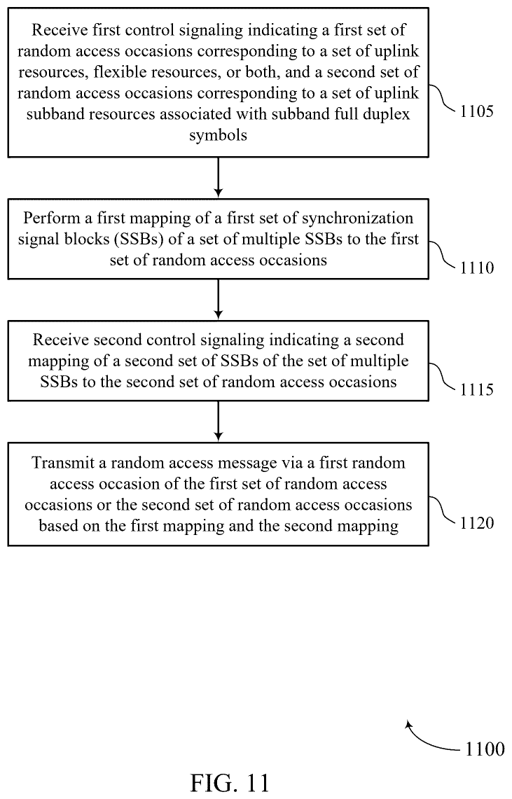

FIG. 11 shows a flowchart illustrating a method 1100 that supports SBFD RO use and mapping scenarios in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling indicating a first set of ROs corresponding to a set of uplink resources, flexible resources, or both, and a second set of ROs corresponding to a set of uplink subband resources associated with SBFD symbols. The operations of 1105 may be performed in accordance with examples as disclosed herein. In some examples, aspects of the operations of 1105 may be performed by a RO manager 925 as described with reference to FIG. 9.

At 1110, the method may include performing a first mapping of a first set of SSBs of a set of multiple SSBs to the first set of ROs. The operations of 1110 may be performed in accordance with examples as disclosed herein. In some examples, aspects of the operations of 1110 may be performed by a RO mapping manager 930 as described with reference to FIG. 9.

At 1115, the method may include receiving second control signaling indicating a second mapping of a second set of SSBs of the set of multiple SSBs to the second set of ROs. The operations of 1115 may be performed in accordance with examples as disclosed herein. In some examples, aspects of the operations of 1115 may be performed by a RO mapping manager 930 as described with reference to FIG. 9.

At 1120, the method may include transmitting a random access message via a first RO of the first set of ROs or the second set of ROs based on the first mapping and the second mapping. The operations of 1120 may be performed in accordance with examples as disclosed herein. In some examples, aspects of the operations of 1120 may be performed by a RA message manager 935 as described with reference to FIG. 9.

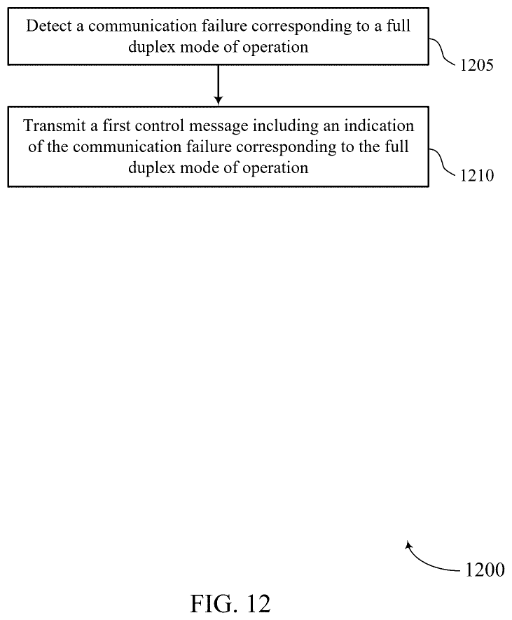

FIG. 12 shows a flowchart illustrating a method 1200 that supports SBFD RO use and mapping scenarios in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include detecting a communication failure corresponding to a full duplex mode of operation. The operations of 1205 may be performed in accordance with examples as disclosed herein. In some examples, aspects of the operations of 1205 may be performed by a communication failure manager 940 as described with reference to FIG. 9.

At 1210, the method may include transmitting a first control message including an indication of the communication failure corresponding to the full duplex mode of operation. The operations of 1210 may be performed in accordance with examples as disclosed herein. In some examples, aspects of the operations of 1210 may be performed by a communication failure manager 940 as described with reference to FIG. 9.

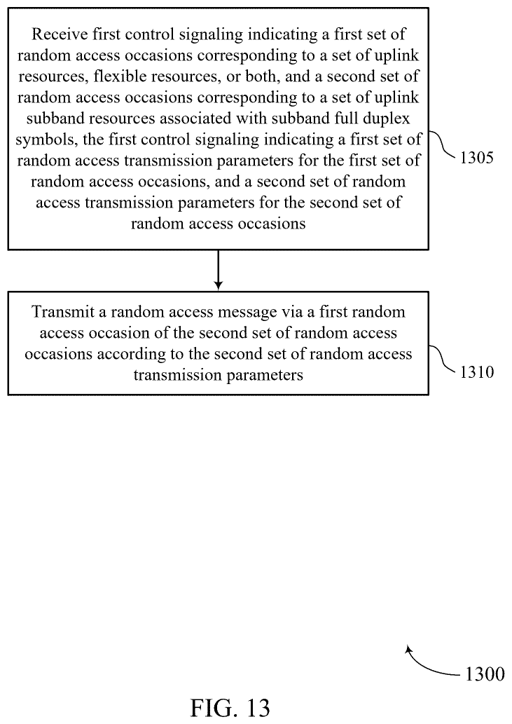

FIG. 13 shows a flowchart illustrating a method 1300 that supports SBFD RO use and mapping scenarios in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling indicating a first set of ROs corresponding to a set of uplink resources, flexible resources, or both, and a second set of ROs corresponding to a set of uplink subband resources associated with SBFD symbols, the first control signaling indicating a first set of random access transmission parameters for the first set of ROs, and a second set of random access transmission parameters for the second set of ROs. The operations of 1305 may be performed in accordance with examples as disclosed herein. In some examples, aspects of the operations of 1305 may be performed by a RO manager 925 as described with reference to FIG. 9.

At 1310, the method may include transmitting a random access message via a first RO of the second set of ROs according to the second set of random access transmission parameters. The operations of 1310 may be performed in accordance with examples as disclosed herein. In some examples, aspects of the operations of 1310 may be performed by a RA message manager 935 as described with reference to FIG. 9.

The following provides an overview of aspects of the present disclosure:

Aspect 1: A method for wireless communications at a UE, comprising: receiving first control signaling indicating a first set of ROs corresponding to a set of uplink resources, flexible resources, or both, and a second set of ROs corresponding to a set of uplink subband resources associated with subband full duplex symbols; performing a first mapping of a first set of SSBs of a plurality of SSBs to the first set of ROs; receiving second control signaling indicating a second mapping of a second set of SSBs of the plurality of SSBs to the second set of ROs; and transmitting a random access message via a first RO of the first set of ROs or the second set of ROs based at least in part on the first mapping and the second mapping.

Aspect 2: The method of aspect 1, wherein the first set of SSBs associated with the first set of ROs according to the first mapping correspond to a first set of consecutive SSB indices in ascending order, and the second set of SSBs associated with the second set of ROs according to the second mapping correspond to a second set of SSB indices.

Aspect 3: The method of any of aspects 1 through 2, wherein the first set of SSBs associated with the first set of ROs according to the first mapping correspond to a first set of consecutive SSB indices in descending order, and the second set of SSBs associated with the second set of SSBs according to the second mapping correspond to a second set of SSB indices.

Aspect 4: The method of any of aspects 1 through 3, wherein the second set of SSBs correspond to a set of prioritized beams of a plurality of candidate beams, each of the set of prioritized beams associated with a respective spatial direction based at least in part on traffic, UE location, channel quality, or any combination thereof.

Aspect 5: The method of any of aspects 1 through 4, wherein a set of beams corresponding to the second set of SSBs are based at least in part on a predicted mobility of the UE, historic beam failure data corresponding to the UE, a direction of each beam of the set of beams, or any combination thereof.

Aspect 6: The method of any of aspects 1 through 5, wherein the first set of ROs correspond to uplink or flexible symbols, and the second set of ROs correspond to subband full duplex symbols configured on downlink symbols or flexible symbols.

Aspect 7: The method of any of aspects 1 through 6, wherein receiving the first control signaling comprises: receiving a first control message indicating the first set of ROs; and receiving second control signaling indicating the second set of ROs.

Aspect 8: The method of any of aspects 1 through 7, wherein receiving the first control signaling comprises: receiving a first control message comprising the first set of ROs and the second set of ROs.

Aspect 9: The method of any of aspects 1 through 8, wherein the second control signaling comprises a radio resource control message comprising a bitmap indicating the second set of SSBs mapped to the second set of ROs according to the second mapping.

Aspect 10: The method of any of aspects 1 through 9, wherein the second control signaling comprises or a system information block indicating the second mapping of the second set of SSBs of the plurality of SSBs to the second set of ROs.

Aspect 11: A method for wireless communications at a UE, comprising: detecting a communication failure corresponding to a full duplex mode of operation; and transmitting a first control message comprising an indication of the communication failure corresponding to the full duplex mode of operation.

Aspect 12: The method of aspect 11, wherein the indication of the communication failure comprises a request to disable a set of ROs associated with the full duplex mode of operation.

Aspect 13: The method of aspect 12, further comprising: receiving, based at least in part on transmitting the first control message, a second control message disabling the set of ROs.

Aspect 14: The method of any of aspects 11 through 13, wherein the indication of the communication failure comprises a request to disable the full duplex mode of operation.

Aspect 15: The method of aspect 14, further comprising: receiving, based at least in part on transmitting the first control message, a second control message disabling the full duplex mode of operation.

Aspect 16: The method of any of aspects 11 through 15, further comprising: generating one or more cross-link interference measurements according to the full duplex mode of operation, wherein transmitting the first control message is based at least in part on the one or more cross-link interference measurements satisfying a cross-link interference measurement threshold.

Aspect 17: The method of any of aspects 11 through 16, further comprising: determining that a quantity or duration of detected cross-link interference satisfies a threshold quantity or duration of cross-link interference, wherein transmitting the first control message is based at least in part on the quantity of failed random access transmissions satisfying the threshold quantity of failed random access transmissions.

Aspect 18: The method of any of aspects 11 through 17, further comprising: transmitting capability information indicating that the UE is capable of transmitting the first control message comprising the indication of the communication failure, wherein transmitting the first control message is based at least in part on transmitting the capability information.

Aspect 19: A method for wireless communications at a UE, comprising: receiving first control signaling indicating a first set of ROs corresponding to a set of uplink resources, flexible resources, or both, and a second set of ROs corresponding to a set of uplink subband resources associated with subband full duplex symbols, the first control signaling indicating a first set of random access transmission parameters for the first set of ROs, and a second set of random access transmission parameters for the second set of ROs; and transmitting a random access message via a first RO of the second set of ROs according to the second set of random access transmission parameters.

Aspect 20: The method of aspect 19, wherein the first set of random access transmission parameters comprises a first maximum random access transmit power, and the second set of random access transmission parameters comprises a second maximum random access transmit power that is lower than first maximum random access transmit power.

Aspect 21: The method of aspect 20, wherein the first set of random access transmission parameters comprises a first power ramping step value, and the second set of random access transmission parameters comprises a second power ramping step value that is smaller than first power ramping step value.

Aspect 22: The method of any of aspects 20 through 21, wherein the first set of random access transmission parameters comprises a first target received power value, and the second set of random access transmission parameters comprises a second target received power value that is smaller than first target received power value.

Aspect 23: The method of aspect 22, further comprising: selecting a preamble length for the random access message according to a link budget and the second maximum random access transmit power, the second target received power value, the second power ramping step value, or any combination thereof.

Aspect 24: The method of any of aspects 20 through 23, wherein the first set of random access transmission parameters comprises a first preamble length, and the second set of random access transmission parameters comprises a second preamble length that is longer than first preamble length.

Aspect 25: The method of any of aspects 19 through 24, wherein the first set of random access transmission parameters comprises a first preamble format, and the second set of random access transmission parameters comprises a second preamble format.

Aspect 26: The method of aspect 25, wherein a first field in a first control message of the first control signaling comprises an indication of the first preamble format, and a second field in a second control message of the first control signaling comprises an indication of the second preamble format.

Aspect 27: The method of aspect 26, wherein the indication of the first preamble format comprises an indication of a first quantity of symbols corresponding to the first preamble format, the indication of the second preamble format comprises an indication of a second quantity of symbols corresponding to the second preamble format, and the second quantity of symbols is greater than the first quantity of symbols.

Aspect 28: The method of any of aspects 25 through 27, wherein a first field in a single control message comprising the first control signaling comprises an indication of a first quantity of symbols for a random access preamble.

Aspect 29: The method of aspect 28, further comprising: transmitting the random access message according to the second preamble format and the first quantity of symbols for the first preamble format; applying an offset value to the first quantity of symbols; and transmitting a second random access message via a first RO of the first set of ROs according to the first preamble format and via a second quantity of symbols that is less than the first quantity of symbols according to the offset value.

Aspect 30: The method of any of aspects 19 through 29, wherein receiving the first control signaling comprises: receiving a first control message indicating the first set of ROs; and receiving second control signaling comprising the second set of ROs.

Aspect 31: The method of any of aspects 19 through 30, wherein receiving the first control signaling comprises: receiving a first control message comprising the first set of ROs and the second set of ROs.

Aspect 32: A UE for wireless communications, comprising one or more memories storing processor-executable code, and one or more processors coupled with the one or more memories and individually or collectively operable to execute the code to cause the UE to perform a method of any of aspects 1 through 10.

Aspect 33: A UE for wireless communications, comprising at least one means for performing a method of any of aspects 1 through 10.

Aspect 34: A non-transitory computer-readable medium storing code for wireless communications, the code comprising instructions executable by one or more processors to perform a method of any of aspects 1 through 10.

Aspect 35: A UE for wireless communications, comprising one or more memories storing processor-executable code, and one or more processors coupled with the one or more memories and individually or collectively operable to execute the code to cause the UE to perform a method of any of aspects 11 through 18.

Aspect 36: A UE for wireless communications, comprising at least one means for performing a method of any of aspects 11 through 18.

Aspect 37: A non-transitory computer-readable medium storing code for wireless communications, the code comprising instructions executable by one or more processors to perform a method of any of aspects 11 through 18.

Aspect 38: A UE for wireless communications, comprising one or more memories storing processor-executable code, and one or more processors coupled with the one or more memories and individually or collectively operable to execute the code to cause the UE to perform a method of any of aspects 19 through 31.

Aspect 39: A UE for wireless communications, comprising at least one means for performing a method of any of aspects 19 through 31.

Aspect 40: A non-transitory computer-readable medium storing code for wireless communications, the code comprising instructions executable by one or more processors to perform a method of any of aspects 19 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a first set of random access occasions corresponding to a set of uplink resources, flexible resources, or both, and a second set of random access occasions corresponding to a set of uplink subband resources associated with subband full duplex symbols;
perform a first mapping of a first set of synchronization signal blocks (SSBs) of a plurality of SSBs to the first set of random access occasions;
receive second control signaling indicating a second mapping of a second set of SSBs of the plurality of SSBs to the second set of random access occasions; and
transmit a random access message via a first random access occasion of the first set of random access occasions or the second set of random access occasions based at least in part on the first mapping and the second mapping.

2. The UE of claim 1, wherein the first set of SSBs associated with the first set of random access occasions according to the first mapping correspond to a first set of consecutive SSB indices in ascending order, and the second set of SSBs associated with the second set of random access occasions according to the second mapping correspond to a second set of SSB indices.

3. The UE of claim 1, wherein the first set of SSBs associated with the first set of random access occasions according to the first mapping correspond to a first set of consecutive SSB indices in descending order, and the second set of SSBs associated with the second set of SSBs according to the second mapping correspond to a second set of SSB indices.

4. The UE of claim 1, wherein the second set of SSBs correspond to a set of prioritized beams of a plurality of candidate beams, each of the set of prioritized beams associated with a respective spatial direction based at least in part on traffic, UE location, channel quality, or any combination thereof.

5. The UE of claim 1, wherein a set of beams corresponding to the second set of SSBs are based at least in part on a predicted mobility of the UE, historic beam failure data corresponding to the UE, a direction of each beam of the set of beams, or any combination thereof.

6. The UE of claim 1, wherein the first set of random access occasions correspond to uplink or flexible symbols, and the second set of random access occasions correspond to subband full duplex symbols configured on downlink symbols or flexible symbols.

7. The UE of claim 1, wherein, to receive the first control signaling, the one or more processors are individually or collectively operable to execute the code to cause the UE to:
receive a first control message indicating the first set of random access occasions; and
receive second control signaling indicating the second set of random access occasions.

8. The UE of claim 1, wherein, to receive the first control signaling, the one or more processors are individually or collectively operable to execute the code to cause the UE to:
receive a first control message comprising the first set of random access occasions and the second set of random access occasions.

9. The UE of claim 1, wherein the second control signaling comprises a radio resource control message comprising a bitmap indicating the second set of SSBs mapped to the second set of random access occasions according to the second mapping.

10. The UE of claim 1, wherein the second control signaling comprises or a system information block indicating the second mapping of the second set of SSBs of the plurality of SSBs to the second set of random access occasions.

11. A user equipment (UE), comprising:
one or more memories storing processor-executable code; and
one or more processors coupled with the one or more memories and individually or collectively operable to execute the code to cause the UE to:
detect a communication failure corresponding to a full duplex mode of operation; and
transmit a first control message comprising an indication of the communication failure corresponding to the full duplex mode of operation.

12. The UE of claim 11, wherein the indication of the communication failure comprises a request to disable a set of random access occasions associated with the full duplex mode of operation.

13. The UE of claim 12, wherein the one or more processors are individually or collectively further operable to execute the code to cause the UE to:
receive, based at least in part on transmitting the first control message, a second control message disabling the set of random access occasions.

14. The UE of claim 11, wherein the indication of the communication failure comprises a request to disable the full duplex mode of operation.

15. The UE of claim 14, wherein the one or more processors are individually or collectively further operable to execute the code to cause the UE to:
receive, based at least in part on transmitting the first control message, a second control message disabling the full duplex mode of operation.

16. The UE of claim 11, wherein the one or more processors are individually or collectively further operable to execute the code to cause the UE to:
generate one or more cross-link interference measurements according to the full duplex mode of operation, wherein transmitting the first control message is based at least in part on the one or more cross-link interference measurements satisfying a cross-link interference measurement threshold.

17. The UE of claim 11, wherein the one or more processors are individually or collectively further operable to execute the code to cause the UE to:
determine that a quantity or duration of detected cross-link interference satisfies a threshold quantity or duration of cross-link interference, wherein transmitting the first control message is based at least in part on the quantity of failed random access transmissions satisfying the threshold quantity of failed random access transmissions.

18. The UE of claim 11, wherein the one or more processors are individually or collectively further operable to execute the code to cause the UE to:
transmit capability information indicating that the UE is capable of transmitting the first control message comprising the indication of the communication failure, wherein transmitting the first control message is based at least in part on transmitting the capability information.

19. A user equipment (UE), comprising:
one or more memories storing processor-executable code; and
one or more processors coupled with the one or more memories and individually or collectively operable to execute the code to cause the UE to:
receive first control signaling indicating a first set of random access occasions corresponding to a set of uplink resources, flexible resources, or both, and a second set of random access occasions corresponding to a set of uplink subband resources associated with subband full duplex symbols, the first control signaling indicating a first set of random access transmission parameters for the first set of random access occasions, and a second set of random access transmission parameters for the second set of random access occasions; and
transmit a random access message via a first random access occasion of the second set of random access occasions according to the second set of random access transmission parameters.

20. The UE of claim 19, wherein the first set of random access transmission parameters comprises a first maximum random access transmit power, and the second set of random access transmission parameters comprises a second maximum random access transmit power that is lower than first maximum random access transmit power.

21. The UE of claim 20, wherein the first set of random access transmission parameters comprises a first power ramping step value, and the second set of random access transmission parameters comprises a second power ramping step value that is smaller than first power ramping step value.

22. The UE of claim 21, wherein the first set of random access transmission parameters comprises a first target received power value, and the second set of random access transmission parameters comprises a second target received power value that is smaller than first target received power value.

23. The UE of claim 22, wherein the one or more processors are individually or collectively further operable to execute the code to cause the UE to:
select a preamble length for the random access message according to a link budget and the second maximum random access transmit power, the second target received power value, the second power ramping step value, or any combination thereof.

24. The UE of claim 20, wherein the first set of random access transmission parameters comprises a first preamble length, and the second set of random access transmission parameters comprises a second preamble length that is longer than first preamble length.

25. The UE of claim 19, wherein the first set of random access transmission parameters comprises a first preamble format, and the second set of random access transmission parameters comprises a second preamble format.

26. The UE of claim 25, wherein a first field in a first control message of the first control signaling comprises an indication of the first preamble format, and a second field in a second control message of the first control signaling comprises an indication of the second preamble format.

27. The UE of claim 26, wherein the indication of the first preamble format comprises an indication of a first quantity of symbols corresponding to the first preamble format, the indication of the second preamble format comprises an indication of a second quantity of symbols corresponding to the second preamble format, and the second quantity of symbols is greater than the first quantity of symbols.

28. The UE of claim 25, wherein a first field in a single control message comprising the first control signaling comprises an indication of a first quantity of symbols for a random access preamble.

29. The UE of claim 28, wherein the one or more processors are individually or collectively further operable to execute the code to cause the UE to:
transmit the random access message according to the second preamble format and the first quantity of symbols for the first preamble format;
apply an offset value to the first quantity of symbols; and
transmit a second random access message via a first random access occasion of the first set of random access occasions according to the first preamble format and via a second quantity of symbols that is less than the first quantity of symbols according to the offset value.

30. The UE of claim 19, wherein, to receive the first control signaling, the one or more processors are individually or collectively operable to execute the code to cause the UE to:
receive a first control message indicating the first set of random access occasions; and
receive second control signaling comprising the second set of random access occasions.
